(19) United States
(12) Patent Application Publication
(10) Pub. No.: US 2004/0249689 A1
(43) Pub. Date: Dec. 9, 2004

(54) Basic business integrating application system, basic business support method, program for causing computer to execute the method, and computer-readable recording medium containing the program

(76) Inventors: Hitoshi Naraki, Tokyo (JP); Kazuo Mitsui, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/491,529

(22) PCT Filed: May 17, 2002
(86) PCT No.: PCT/JP02/04803

(51) Int. Cl. G06F 17/60

(52) U.S. Cl. 705/7

(57) ABSTRACT

An enterprise resource planning application system provided in the form of a plurality of business packages supports a backbone executed by a computer system in an integrated manner. The enterprise resource planning application system extracts from a plurality of standard functions provided by the business packages standard functions that realize a business process common to different types of business, and executes the business process only by a combination of the standard functions extracted.

### TECHNICAL FIELD

The present invention relates to an enterprise resource planning application system for supporting the execution of the backbone business of an enterprise in an integrated manner, an enterprise resource planning method, a program for making a computer execute the method, and a computer readable recording medium having the program recorded therein.

### BACKGROUND ART

Recently, since enterprises are exposed to diversification of customer's demands, a huge number of products flooding in the market, and international competition (mega competition), the types of products and services to be handled are likely to increase, and the life cycle thereof becomes short. To keep up with such a situation, it becomes important for the enterprises to quickly find and produce products and services which customers desire, as well as to improve the quality, cost, and delivery of the products and services of their own.

Particularly, since the information system in an enterprise is closely related to the business process, there is a possibility that the information system is to create a new business rule for improving productivity, customer service, and competitive power of the enterprise. On the other hand, in the industrial information systems, expected results of investment for computerization are so diverse that it is difficult to recognize the effect of the investment.

Therefore, an information system package referred to as enterprise resource planning (ERP) package (integrated business package) targeting the backbone business of an enterprise is attracting attention. The ERP and the ERP package will be explained in detail.

At first, discrimination between the concept of the ERP and the ERP package will be explained. Normally, ERP refers to ERP package products, but strictly speaking, “ERP” refers to management concept as described below. Further, the information basis for realizing the management concept of the ERP is referred to as an “ERP system”; a package product for materializing the ERP system is referred to as an “ERP package”. In this specification, these three words are discriminated from each other, in order to clarify the characteristics of the present invention.

The ERP refers to the management concept for planning and management for horizontally understanding the business process constituting a value chain that provides a value to customers, across departments and organizations in the business management of the enterprise, such as purchasing, production, sales, accounting, and personnel, and optimizing the utilization of the business resources in the whole value chain.

The ERP system refers to an information basis for materializing the ERP concept in the management of the enterprise, and specifically, is a new information system for the backbone business, being a backbone of the business management of the enterprise. The ERP package refers to a tool enabling quick construction of the new information system for materializing the ERP concept.

The outline of the ERP package forming the backbone for realizing the ERP will be explained below. The ERP package refers to a package product developed by domestic and foreign vendors. Typical examples include R/3 from SAP AG (Germany), Oracle Applications from Oracle Corporation (USA), and BAAN IV from Baan Corporation (Holland).

FIG. 9 illustrates the configuration of a general ERP package. As shown in FIG. 9, an ERP package 12 is formed of many functional modules for supporting the backbone business in the enterprise, and can handle a wide range of business in an integrated manner via an integrated database 10. The point of “integrated” is one of the important aims of the ERP and the ERP package, and this is why the ERP package is referred to as the “integrated business package”. Particularly, in FIG. 9, the flow of the backbone business such as procurement, production, distribution, and sales, referred to as a “supply chain”, and integration thereof with the accountancy are the feature of the ERP package, such that the input business slip is directly reflected in accounting.

The characteristic points of the ERP and the ERP package will be explained. Characteristic points common to many ERP packages are generally as follows:

(1) The setup (whole image) is clear.

(2) An introduction and construction procedure (introduction method) is prepared.

(3) Modules dealing with the backbone business are abundant and respective functions are complete.

(4) To deal with the latest information technology and openness are ensured.

(5) International standard is adopted in the information technology.

(6) International dealing premising for the operation in the multi-national environment is incorporated.

(7) Flexibility and expandability with respect to a future change in the business contents or the management organization are ensured.

(8) An interface function with existing systems and other packages is complete.

(9) Unification and sharing of data and information is realized by adopting the integrated database.

(10) Maintenance service is separately provided.

(11) Training at the time of introduction and the support system are complete.

To put these characteristics in order, the largest characteristics of the ERP package are that firstly, functions aiming at integration of the backbone business are complete, and secondly, products exist already and are maintained as a package. Other characteristics include standard and international orientation, flexibility and expandability, utilization of new information technology, completeness of planning and management functions using the integrated information.

The ERP system will now be explained. Various and large effects are expected in the ERP system, but the realization thereof is not so easy, and there are many failures as well as successful examples in introducing the ERP system. Therefore, the difficulty and hints in introducing the ERP system have been discussed for long time. Therefore, the purpose and the expected effects of the ERP system and the ERP package will be explained below with subjects thereof, from both advantageous and disadvantageous aspects.

At first, there is the effect that the cost for system development and maintenance can be reduced. In the conventional backbone business system, a program with full of patches is maintained on the old information technology, in many cases. It has been put in question that the system section holds huge backlog, and cannot realize a system function in line with the current, though having a large maintenance load. On the other hand, when the whole backbone business system in the enterprise is to be rebuilt from the start in order to solve this problem, huge cost and period are required.

On the other hand, the ERP package is an already made product, and new information technology and business functions of the international standard are incorporated therein abundantly, and long-term flexibility and expandability of the system are planned by the selection of functions by parameter setting. Therefore, reduction in the system development and maintenance cost can be expected.

Secondly, there is the effect that the system construction period can be shortened. With the established ERP package product, programming, which has been required in the conventional fabricated information system, can be considerably reduced. Further, reduction in the designing stage can be aimed by using a business model (template), and if the ERP package is used, reduction in the system construction period can be expected.

Recently, a change cycle in the business environment becomes particularly short, such as reduction in the product cycle, and hence quickness is required in the business management, and the speed in constructing the information system supporting the business is considered to be important.

Thirdly, there is the effect that the efficiency of business process can be improved by sharing the information and integration. In the conventional industrial information system, systematization is realized by department and by business function respectively, which becomes an obstruction to the integration of the whole enterprise. However, by constructing the ERP system, a series of backbone business inside and outside the enterprise is integrated via the database, and hence high efficiency of the business process can be expected.

By uniformly controlling and sharing the business data, useless work such as duplicated input of the same data and inquiries to other departments can be reduced. Further, since the information between departments can be shared on the real time basis, decisions taking other departments into consideration can be made at the end user level. Even in the customer service, since the information in the respective departments can be overlooked, quicker and more accurate dealing than before can be expected. For example, when there is an inquiry relating to an order from a customer, all information of the departments relating to the order can be referred to, and the response time can be greatly reduced.

Fourthly, there is the effect that the planning and management level can be improved. If integration of the business information can be performed by realizing the ERP system, and even though the product, manufacturing base, and the sales base are different, if the information is gathered in the common setup, unified management through figures can be performed over the whole enterprise.

Particularly, the integrated database in the ERP package has a property of an “account book type database”, which handles individual slip data without collecting and arranging these together. Therefore, versatile data search and processing can be freely performed later. Accordingly, when the same sales add initial cost are analyzed, analysis is possible by various multi-dimensional modes, such as product, factory, sales office, person in charge, date, and price range, and if there is an outlier, further analysis is possible by drill down.

Further, accurate and quick management decisions become possible through the analysis using real-time information, and if the integrated database is used, planning operations such as quick rearrangement of managerial resources in the enterprise can be performed. For example, it is decided to discontinue a business predicted to bear no profit in the future, and invest the managerial resources to a growth business.

Fifthly, there is the effect that the know-how accumulated in other companies can be used. The vendor of the ERP package selects a set of excellent business functions and the know-how based on the introduction results and experiences up to now, and accumulates these in the form of product functions, industrial solutions, templates, and introduction support tools. One object of introducing the ERP package is that the know-how accumulated in other companies can be used for the own company.

The accumulated business function set is referred to as “Best Practice”, and used for advertising the ERP package. If the business process is revolutionized by using the Best Practice, business process reengineering (BPR) can be promoted.

FIG. 10 is a table indicating general business functions generally equipped in many ERP packages, which are now distributed inside and outside the country. As shown in FIG. 10, an enterprise can buy and introduce only the required functional modules in the ERP package. At the time of introduction, customization by parameter setting and more or less additional development such as add-on development described later are often performed in consideration of characteristics of the enterprise. In the ERP package, a development and customization support function and an operation control support function are prepared, in addition to the business function modules shown in FIG. 10 and the integrated database.

Actually, therefore, developers, vendors, and consulting firms, who provide the integrated business package or support the introduction thereof, prepare original introduction methodology and template groups for supporting the introduction, with respect to companies that introduce the ERP package, in order to improve the efficiency in package introduction, and to prevent development return. Here, the template group is a model group representing the operational specification and the system specification included in the package systematically, and for example, there are a business system model, and a business process model.

Customization means that a parameter is set in a customization table, so that a function included generally in the ERP package performs a desired behavior. As described above, the ERP package is a package preparing abundant functions so as to be adaptable to various business forms in various industries. Therefore, when all the business requirements can be covered within the range, the system can be realized by only the customization, without performing the program development for additional functions.

In the ERP package, a scenario for performing generation of the templates and appropriate selection is often prepared. Therefore, at the time of introduction of the ERP package, by using this scenario well as the template for reengineering, introduction of the system can be easily performed within a short time.

As an actual problem, however, many problems that cannot be reengineered only under the circumstances of the own company may occur at the time of system development. For example, development of additional functions becomes often necessary at the time of system introduction of the ERP package, due to a requirement to deal with in a form different from the ERP package standard due to the relation with customers or clients, a requirement to be included due to a restriction of the peripheral systems other than the ERP system, or a requirement for efficiently performing the business process that cannot be handled by the standard method, because it is a critical business process timewise and in view of resources.

The ERP package normally prepares a development environment and supports the special purpose programming language, such as the fourth generation language, as the program development language, so that the additional function development can be performed efficiently. For the input and output to and from the screen, there is often a function of easily building up the input and output on a special processor. A screen for simple search can be easily developed by using a tool such as a report writer or a report printer, without programming using the special purpose programming language described above.

In the ERP package, how to deal with the version-upgrades of the ERP package is a point to be noted, at the time of developing additional functions. Particularly, in the ERP package, major version-upgrades have been currently performed at a pace of every year, upon reception of function enhancement requirements, with recent rapid progress of information technology (IT). Therefore, if update is not performed at all times by version-upgrades, the developed system may become out-dated and useless.

Taking such version-upgrades into consideration, in the ERP package, the additional function development is generally divided into two levels, add-on and modify. Add-on is a method of developing database and programs satisfying the requirement in the individual system to deal with the development requirement of the additional functions, with the database and the program, being the standard of the ERP package, left as it is. On the other hand, modify is a method of directly modifying the database and the program generally provided by the ERP package, to deal with the development requirement of the additional functions.

The portion handled by the add-on method can easily deal with the version-upgrades of the ERP package. However, with regard to the portion handled by modify, since there is the possibility that the modified database or program may be inconsistent with the change of the standard database and program for version-upgrades of the ERP package, sufficient study is required beforehand.

As explained above, an enterprise can execute the backbone business efficiently, and the execution of the backbone business can be made more efficient in response to the future progress of technology, by introducing the ERP package to construct the ERP system.

However, since functions in the business system required according to the type of the enterprise, the product, and the business process are multifarious, though abundant functions can be prepared by the packaged product, it is difficult to prepare all necessary functions for all enterprises, including special specification. Therefore, functions of the ERP package actually used in an enterprise, being a particular user, may be only a part of it, but a required function may not be included therein. Therefore, function addition by the add-on method is performed. However, with this method, many functions, which are not used, exist in the ERP package, as well as a function added black box portion, thereby causing a problem that maintenance in the enterprise becomes difficult.

When the backbone business system is constructed using the ERP package, if functions lacking in the ERP package and detailed dealing are developed by the add-on method, there is a problem that the construction period may be required, which is longer than the case of not using the ERP package.

Further, the ERP system itself is only a system that supports the execution of the backbone business. Therefore, in order to improve the planning and control level, the setup in the business and organization that can effectively use the information collected and accumulated by the ERP system, and user training are essential. However, there is generally a plurality of methods for realizing the respective functions in the ERP package, and if the cooperation between standard functions and the additional functions is described in detail, understanding of the system by the user becomes difficult, and time and cost also increase. Therefore, conventional templates provided by the consulting firms or the like have a problem that an understandable and sufficient manual is not attached.

Most of the templates provided for each type of business by the consulting firms or the like are in a newly created input/output form, which is not included in the standard ERP package, so as to follow the operation same as that performed heretofore in the respective companies. Actually, however, in many cases, the processing requiring input over two or three screens is only handled by one screen according to the conventional information system, by using the functions in the standard ERP package.

Particularly, the basic business process such as the supply chain is common to different types of business, and most business processes can be executed by only the functions in the standard ERP package. In other words, the current situation is such that the operation mode of the original ERP package is destroyed, due to the consciousness that the business process in each company is special, and multifariousness of the ERP package.

Further, when the ERP package is to be introduced by providing templates different for each type of business, huge number of steps is naturally required for adjustment between the customer's requirement and the package specification, and a lot of time is required for the development and verification periods, thereby causing a drop of the system construction speed. Thus, system construction over a long period causes a cost increase, not to mention the mental exhaustion of the person in charge of the system. This is one of the reasons why a so-called big bang introduction, in which the ERP package is introduced over the whole business without delay, is few.

It is therefore an object of the present invention to provide an enterprise resource planning application system that realizes the business process common to different types of business by the function in the standard ERP package, thereby enabling improvement of the system construction speed and cost reduction, a enterprise resource planning method, a program for making a computer execute the method, and a computer readable recording medium having the program recorded therein.

### DISCLOSURE OF THE INVENTION

An enterprise resource planning application system according to one aspect of the present invention is a system provided in the form of a plurality of business packages, for supporting a backbone executed by a computer system in an integrated manner, wherein the enterprise resource planning application system extracts from a plurality of standard functions provided by the business packages standard functions that realize a business process common to different types of business, and executes the business process only by a combination of the standard functions extracted.

According to this aspect, since the business process can be executed by using only the standard functions prepared in advance in the business package, the backbone business can be executed without performing extra development for adding a function characteristic to the type of business.

An enterprise resource planning application system according to another aspect of the present invention is a system provided in the form of a plurality of business packages, for supporting a backbone executed by a computer system in an integrated manner, wherein the enterprise resource planning application system extracts from a plurality of standard functions provided by the business packages standard functions that realize a business process common to different types of business, and executes the business process by a combination of the standard functions extracted and additional functions that realize a business process common to all types of business.

According to this aspect, the business process common to different types of business can be executed by using only the standard functions prepared in advance in the business package, and the business process common to all types of business, which is not included in the standard functions, can be executed by the additional functions. As a result, the number of required additional functions can be suppressed to minimum.

An enterprise resource planning application system according to still another aspect of the present invention includes additional functions to realize a specific business process for an enterprise in the above aspect.

According to this aspect, the business process characteristic to the enterprise, which is not included in the standard functions, can be executed by the additional functions, thereby enabling flexible dealing with the business different for each enterprise.

An enterprise resource planning application system according to still another aspect of the present invention is such that the business packages includes a package for financial accounting, and the package performs general ledger accounting, accounts receivable management, accounts payable management, funds management, asset accounting, master processing, and settlement accounting, as the standard functions extracted to realize a business process common to different types of business.

According to this aspect, since the financial accountancy is constructed by the standard functions, such as processing for general ledger accounting, accounts receivable management, accounts payable management, funds management, asset accounting, master processing, and settlement accounting, the business process common to different types of business, of the financial accountancy, can be executed.

An enterprise resource planning application system according to still another aspect of the present invention is such that the business packages includes a package for control accounting, and the package performs cost element management, cost center accounting, profit center accounting, internal instruction management, and production instruction management, as the standard functions extracted to realize a business process common to different types of business.

According to this aspect, since the control accounting is constructed by the standard functions, such as processing for cost element management, cost center management, profit center management, internal instruction management, and production instruction management, the business process common to different types of business, of the controlling business, can be executed.

An enterprise resource planning application system according to still another aspect of the present invention is such that the business packages includes a package for sales and distribution, and the package performs purchase orders processing, shipping management, account management, stock transfer, consignment stock, master processing, sales information reporting, and sales planning, as the standard functions extracted to realize a business process common to different types of business.

According to this aspect, since the sales and distribution is constructed by the standard functions, such as processing for handling of purchase orders, shipping management, account management, stock transfer, consignment stock, master, sales information reporting, and sales planning, the business process common to different types of business, of the sales and distribution business, can be executed.

An enterprise resource planning application system according to still another aspect of the present invention is such that the business packages includes a package for material management, and the package performs purchase management, stock control, account checking, balance transfer, stock evaluation adjustment, and purchasing budget, as the standard functions extracted to realize a business process common to different types of business.

According to this aspect, since the material management is constructed by the standard functions, such as processing for purchasing management, stock control, account checking, balance transfer, stock evaluation adjustment, and purchasing budget, the business process common to different types of business, of the material management business, can be executed.

An enterprise resource planning application system according to still another aspect of the present invention is such that the business packages includes a package for a project system, and the package performs project system processing and network processing, as the standard functions extracted to realize a business process common to different types of business.

According to this aspect, since the project system business is constructed by the standard functions, such as project system processing and network processing, the business process common to different types of business, of the project system business, can be executed.

An enterprise resource planning application system according to still another aspect of the present invention is such that the business packages includes a package for production planning, and the package performs master processing, marketing planning, standard planning, material requirements planning, manufacturing instruction processing, and production analysis, as the standard functions extracted to realize a business process common to different types of business.

According to this aspect, since the production planning and control business is constructed by the standard functions, such as processing for master, marketing planning, standard planning, material requirements planning, manufacturing instruction, and production analysis, the business process common to different types of business, of the production planning and control business, can be executed.

An enterprise resource planning application system according to still another aspect of the present invention is such that the business packages includes a package for plant maintenance, and the package performs functional site and equipment processing, work center processing, maintenance task listing, maintenance planning, notification, and instruction processing, as the standard functions extracted to realize a business process common to different types of business.

According to this aspect, since the plant maintenance business is constructed by the standard functions, such as processing for functional site and equipment, work center, maintenance task list, maintenance planning, notification, and instruction, the business process common to different types of business, of the plant maintenance business, can be executed.

An enterprise resource planning application system according to still another aspect of the present invention is a system provided in the form of a plurality of business packages, for supporting by an integrated database a backbone executed by a computer system. The enterprise resource planning application system includes a data input unit for inputting data onto an input sheet for each transaction; a data file conversion unit that converts the data input by the data input unit into a data file in a predetermined format; and a batch input unit that registers contents of the data file in the integrated database, and is used in common between different transactions.

According to this aspect, since the data input for a transaction can be registered in the integrated database by the batch input unit used in common between different transactions, it is not necessary to individually provide a characteristic registration unit different for each transaction.

An enterprise resource planning method according to still another aspect of the present invention is a method using a plurality of business packages, for supporting a backbone executed by a computer system in an integrated manner. The enterprise resource planning method includes executing a business process based on a template obtained by combining the standard functions that are extracted from a plurality of standard functions provided by the business packages to realize the business process common to different types of business.

According to this aspect, since the business process can be executed according to the template prepared by using only the standard functions prepared in advance in the business package, the backbone business can be executed without performing extra development for adding a function characteristic to the type of business.

An enterprise resource planning method according to still another aspect of the present invention is a method using a plurality of business packages, for supporting a backbone executed by a computer system in an integrated manner. The enterprise resource planning method includes executing a business process based on a template obtained by combining standard functions that are extracted from a plurality of standard functions provided by the business packages that realize a business process common to different types of business and additional functions that realize a business process common to all types of business.

According to this aspect, the business process common to different types of business can be executed by using only the standard functions prepared in advance in the business package, and the business process common to all types of business, which is not included in the standard functions, can be executed by the additional functions. As a result, the number of required additional functions can be suppressed to minimum.

An enterprise resource planning method according to still another aspect of the present invention is such that the template includes additional functions to realize a specific business process for an enterprise.

According to this aspect, the business process characteristic to the enterprise, which is not included in the standard functions, can be executed by the additional functions, thereby enabling flexible dealing with the business different for each enterprise.

An enterprise resource planning method according to still another aspect of the present invention is a method using a plurality of business packages, for supporting by an integrated databasesa backbone executed by a computer system. The enterprise resource planning method includes inputting data onto an input sheet for each transaction; converting the data input into a data file in a predetermined format; and registering contents of the data file in the integrated database through a batch input unit that is used in common between different transactions.

According to this aspect, since the data input for a transaction can be registered in the integrated database by the batch input unit used in common between different transactions, it is not necessary to individually provide a characteristic registration unit different for each transaction.

### BRIEF DESCRIPTION OF THE DRAWINGS

FIG. 1 is a block diagram indicating a schematic configuration of an enterprise resource planning application system according to an embodiment;

FIG. 2 illustrates a module group in an ERP package provided in the enterprise resource planning application system according to the embodiment;

FIG. 3 illustrates a part of the functions constructed by parameter setting, in the enterprise resource planning application system according to the embodiment;

FIG. 4 is a flowchart indicating a procedure for performing general-purpose batch input processing in the enterprise resource planning application system according to the embodiment;

FIG. 5 illustrates one example of transactions for which a spreadsheet for batch input is prepared, in the enterprise resource planning application system according to the embodiment;

FIG. 6 illustrates one example of the obtained spreadsheet in the enterprise resource planning application system according to the embodiment;

FIG. 7 illustrates one example of the contents in the generated conversion file, in the enterprise resource planning application system according to the embodiment;

FIG. 8 illustrates one example of a display screen in a general-purpose batch input tool in the enterprise resource planning application system according to the embodiment;

FIG. 9 illustrates the configuration of a general ERP package; and

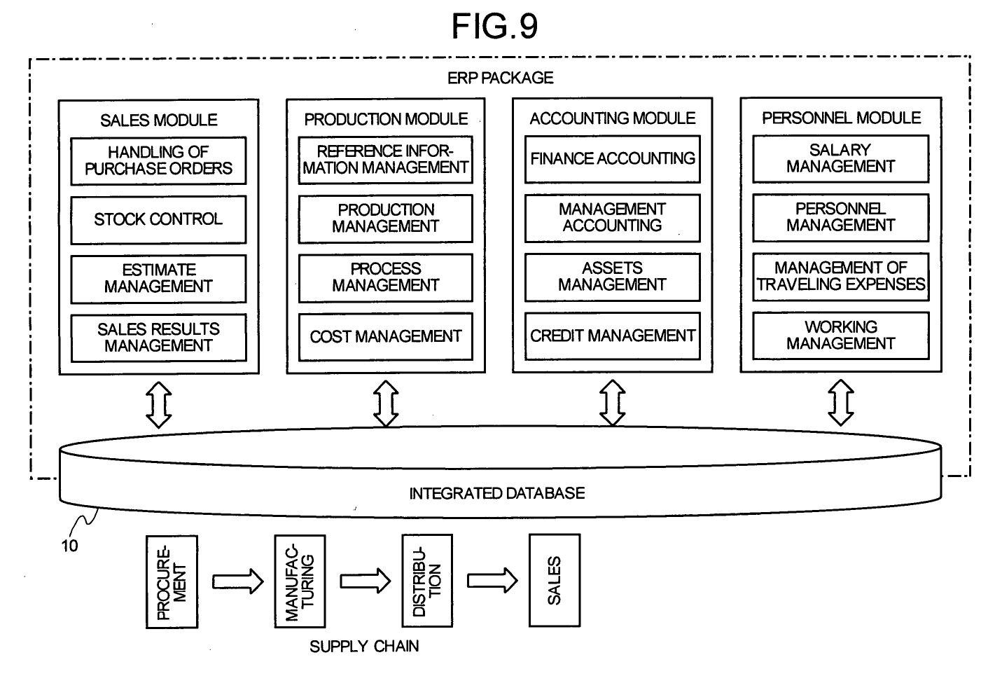

FIG. 10 is a chart illustrating general business functions included in many ERP packages as a standard.

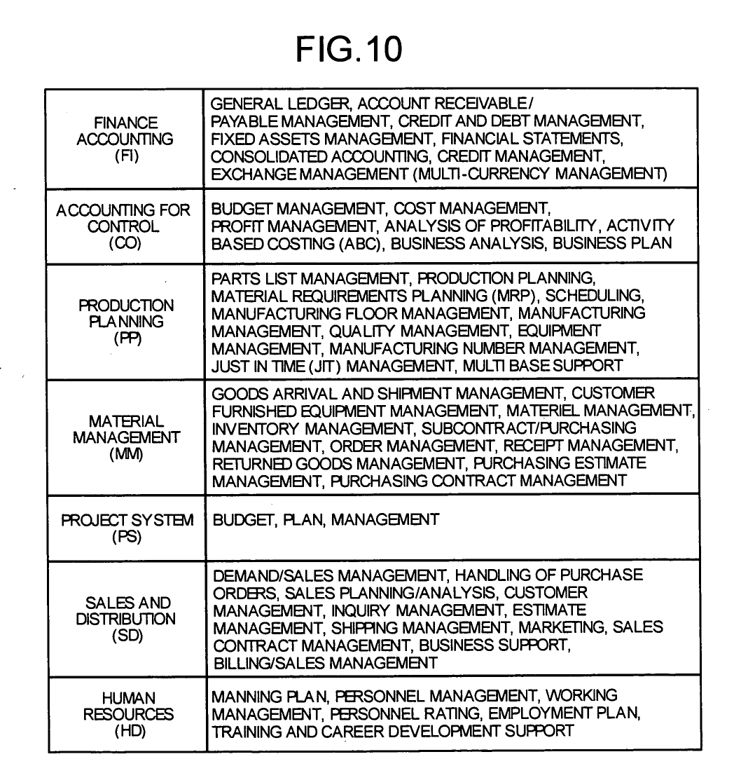

### BEST MODE FOR CARRYING OUT THE INVENTION

Exemplary embodiments of the enterprise resource planning application system and the enterprise resource planning method according to the present invention will be explained in detail, with reference to the accompanying drawings. However, the present invention is not limited by the embodiments.

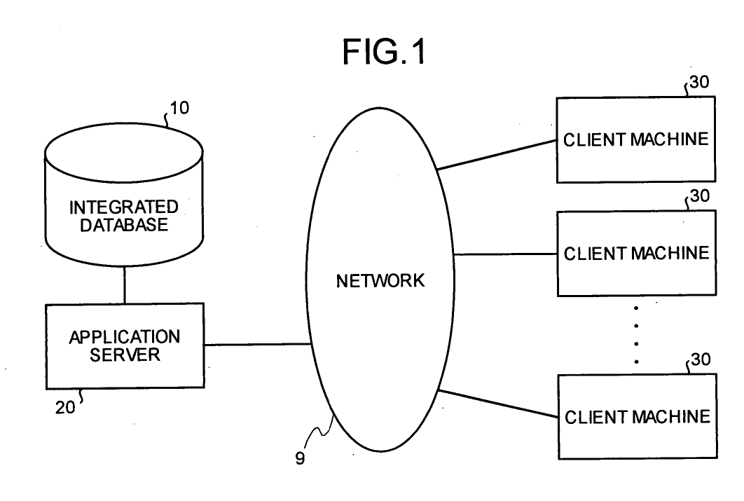

FIG. 1 is a block diagram indicating a schematic configuration of the enterprise resource planning application system according to the embodiment. In FIG. 1, integrated database 10 is database in which various masters (clients, suppliers, items, slip data, and the like) of respective enterprises are registered. An application server 20 has a role to mediate the access to the integrated database 10, with an ERP package installed therein, and respond to a request for login authentication from the outside via a network 9 or for realizing the function of the ERP package.

A client machine 30 is the apparatus for performing preparation and reference of various data in the master and accessing the integrated database 10 and the application server 20 via the network 9, and the ERP package is also installed in the client machine 30. The integrated database 10 is built on a memory such as a large capacity magnetic disc unit, and the application server 20 and the client machine 30 have the same configuration as that of the conventional computer system. The network 9 is, for example, local area network (LAN), wide area network (WAN), or the Internet, and a physical medium or system that transmits data by a common communication protocol such as TCP/IP.

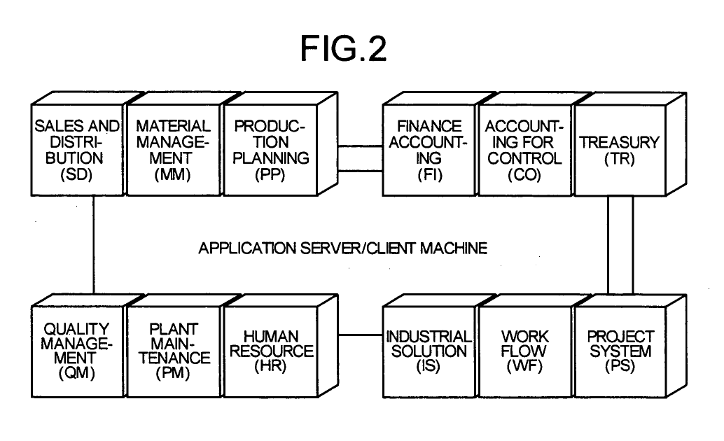

FIG. 2 illustrates a module group in an ERP package provided in the enterprise resource planning application system according to the embodiment. Briefly speaking, in FIG. 2, as a module for realizing the system that constructs the business process for the key portion in the logistics, such as procuring materials to manufacture the product, and ship the product upon reception of an order from a customer, there are sales and distribution (hereinafter, “SD”), material management (MM), and production planning (PP).

As a module for realizing the system that supports smooth production activity, there are quality management (QM), and plant maintenance (PM). As a module for realizing the accounting system, there are finance accounting (FI), accounting for control (CO), and treasury (TR).

Further, there are a project system (PS) module for realizing the system that supports individual project type activities from both sides of logistics and accounting, and a human resource (HR) module for realizing the system for salary calculation and personnel management.

In addition, a work flow module for realizing a groupware function can be used, so that cooperation between business functions can be easily established over the respective applications. These modules in the ERP package are created by assuming that these can be used as the standard functions basically in all industries.

In the ERP package, there is a way of thinking such that if it is assumed that the modules by function are plotted on the X-axis, necessary functions should be plotted oh the Y-axis by type of business. This is the industrial solution, and generally, automobile, aviation and. defense, bank, chemical, consumer goods, health industry, high technology, insurance, petroleum and gas, pharmaceuticals, public services, retail, communication, utility, and the like are provided.

From another point of view, these modules connect the system that supports the backbone business functions in the supply chain, such as procurement, production, sales, and distribution, to the management type system such as finance accounting and accounting for control. Further, this is integrated with the system that controls resources, such as people and machines necessary for the supply chain, in an integrated manner, thereby realizing the integrated supply chain management system.

In the enterprise resource planning application system according to the embodiment, respective functions selected by the parameter setting are carefully selected in the ERP package module.

Selection from many functions provided by the ERP package will be explained. In general, the ERP package prepares in advance many functions required for executing the business process matched with the characteristic of the industry as the standard functions, in various types of industry. When realizing an individual system, if a necessary portion is selected according to the needs of the own company, the system can be realized with minimum time and cost, minimizing the necessity of development of additional functions.

These various functions have been built up in the process of creating many systems with many enterprises by the present inventor, continuously considering how an individual function requirement can be generalized, so that the function can be used in many enterprises as the standard function.

For example, if taking the production planning as an example, the optimum method of production planning changes variously according to some factors, for example, whether complicated products including many components are being produced, whether these products are produced individually from designing, and how much standardized products are to be produced with high repeatability.

In the case of this example, the ERP standard package function includes a series of functions of from drafting a production plan, MRP, ordering of materials and parts, material management, processing for accounts payable, production planning of parts machining and assembly, manufacturing cost management, to product stock control, acceptance of order, shipping and billing, and parameters are set on a table referred to as a “customize table”, regarding how to use which function in the individual system.

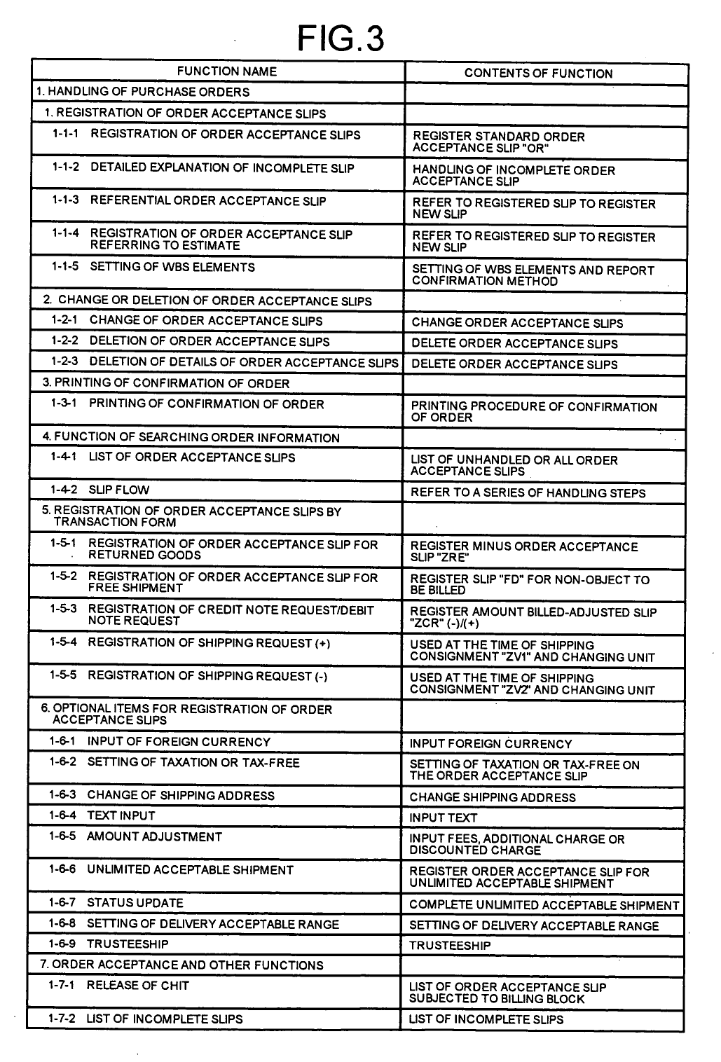

FIG. 3 illustrates a part of the functions constructed by parameter setting, in the enterprise resource planning application system according to the embodiment. In FIG. 3, of the standard functions prepared in the SD, being one of the business modules, the basic processing in the business process for handling of purchase orders, that is, registration of order acceptance slips, change or deletion of order acceptance slips, search of order information, registration of order acceptance slips by transaction form, optional items for registration of order acceptance slips, and order acceptance and other functions are particularly listed up as an example.

Selection functions essential in the business process, that is, functions required in any type of business from the functions prepared in advance has been found by the present inventor, and conventionally, these functions have been transformed and included in different templates for each type of business. Therefore, in the ERP package, various functions have been heretofore prepared so as to deal with the business process of many different types of business, in other words, functions by the least common multiple of the functions required for many types of business have been heretofore prepared. On the other hand, in the enterprise resource planning application system according to the embodiment, of these functions, functions required for any type of business are carefully selected by the greatest common divisor, to construct the template.

When the respective companies use this template, though the input and output form is different from the forms heretofore used in the respective companies, the business process itself does not change. Particularly, in the ERP package, since the customer master is registered in one integrated database, if only the master can be referred, there is no problem in the list display or the like of items to be input or selected in the input form.

Particularly, since the respective functions constituting the template are prepared as standard in the ERP package, version-upgrades of the ERP package on the vendor side can be executed without any problem, thereby enabling quick shift to the business process changed by the version. At the time of version-upgrades, since extra development is not necessary, cost reduction can be also realized.

Other than the one shown in FIG. 3, for example, the template for the finance accounting package is formed of the standard functions, such as processing for general ledger, credit management, accounts payable management, funds management, fixed assets, master, and settlement, and the template for the controlling package is formed of the standard functions, such as processing for cost element management, cost center management, profit center management, internal instructions management, and production instructions management.

The template for the sales and distribution package is formed of the standard functions, such as processing for handling of purchase orders, shipping management, account management, stock transfer, consignment stock handling, master, sales information reporting, and sales planning. The business for the material management package is formed of the standard functions, such as processing for purchasing management, stock control, account checking, balance transfer, stock evaluation adjustment, and purchasing budget.

The template for the project system package is formed of the standard functions, such as project system processing and network processing, the template for the production planning and management package is formed of the standard functions, such as processing for master, marketing planning, standard planning, MRP, manufacturing instruction, and production analysis, and the template for the plant maintenance package is formed of the standard functions, such as processing for functional site and equipment, work center, maintenance task list, maintenance planning, notification, and instruction.

A enterprise resource planning tool for realizing the functions, which are not sufficient with the template formed of these standard functions, that is, functions heretofore developed by the add-on, will be explained below. In the enterprise resource planning application system according to the embodiment, a general-purpose batch input tool, a general-purpose batch output tool, and an accounting data batch checking tool are prepared as the enterprise resource planning tool. The outline of functions of these tools will be explained below in order.

General-Purpose Batch Input Tool

At first, the general-purpose batch input tool will be explained. The general-purpose batch input tool is a tool for registering in the integrated database 10 the input information on the spreadsheet prepared by general-purpose spreadsheet software (EXCEL by Microsoft Corp., Lotus 1-2-3 by Lotus Co., etc.) operating on the client machine 30. Particularly, the conventional batch input tool provided by the ERP vendors or the like is prepared as a program different for each transaction, and it is necessary to activate the program according to the transaction point by point. However, this general-purpose batch input tool operates as a common registration program with respect to all transactions. In other words, registration in the integrated database 10 can be made by one general-purpose batch input tool, only by preparing the spreadsheet for each transaction.

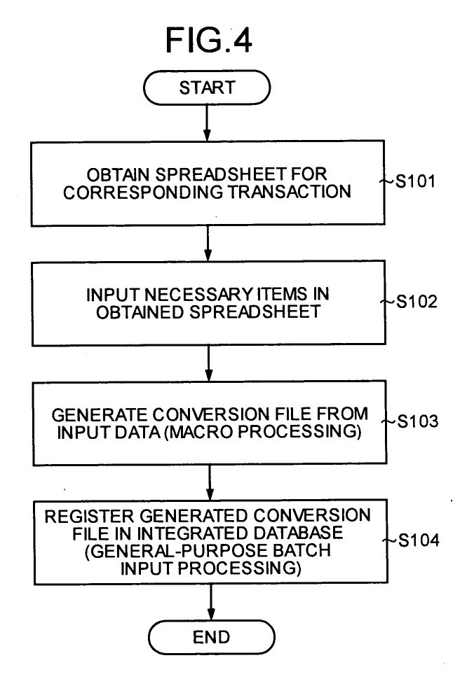

FIG. 4 is a flowchart indicating a procedure for performing general-purpose batch input processing. At first, a user obtains a spreadsheet prepared for a desired transaction, being an object of the batch input (step S101).

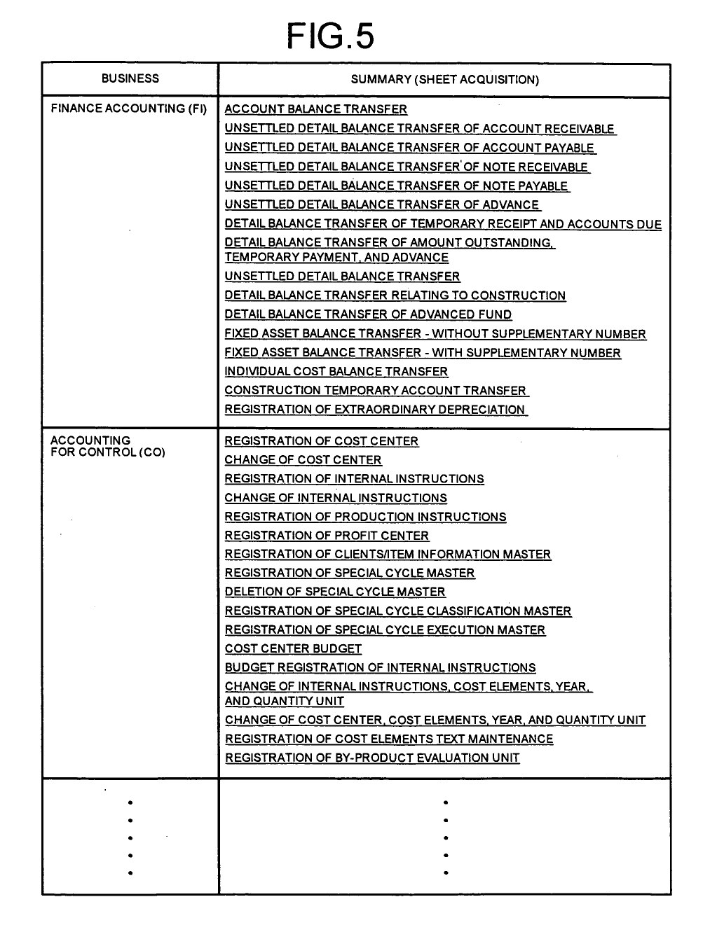

FIG. 5 illustrates one example of transactions for which a spreadsheet for batch input is prepared. At step S101, the user selects a desired transaction from the transactions shown in FIG. 5, for example, to obtain the spreadsheet thereof. This spreadsheet may be downloaded from the application server 20 every time the user selects it, or the client machine 30 may obtain all spreadsheets beforehand from the application server 20.

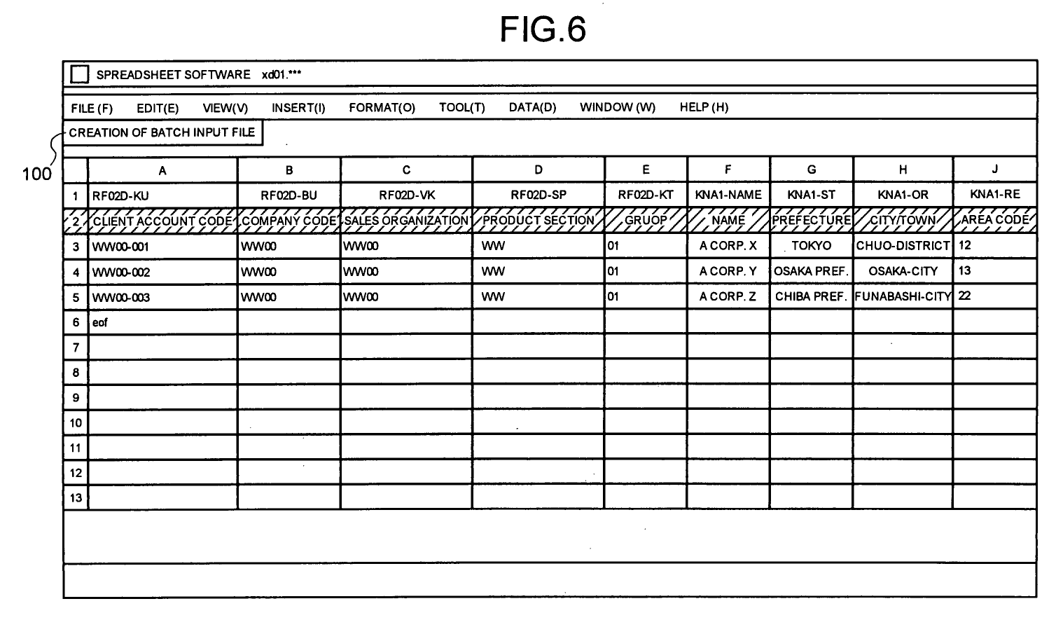

The user then inputs necessary items (data) for registration into the integrated database 10 according to the obtained spreadsheet (step S102). FIG. 6 illustrates one example of the obtained spreadsheet, and particularly indicating a spreadsheet for performing registration in the client/item information master.

When having finished input to a predetermined cell in the spreadsheet shown in FIG. 6, the user executes the conversion file generation processing (step S103). The conversion file generation processing is processing for outputting the contents in the spreadsheet to an intermediate file (according to the conversion file) in a format common to different transactions, and for example, only the contents in the cells in the spreadsheet are sequentially fetched, by using the macro function of the spreadsheet software, converted into ASCII code data and output in a text file. Execution of the macro function is performed by pressing a button 100 in the figure.

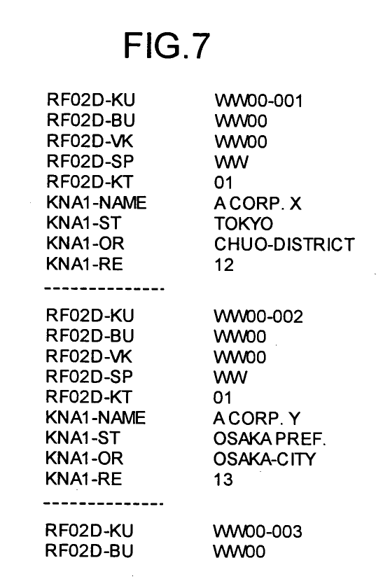

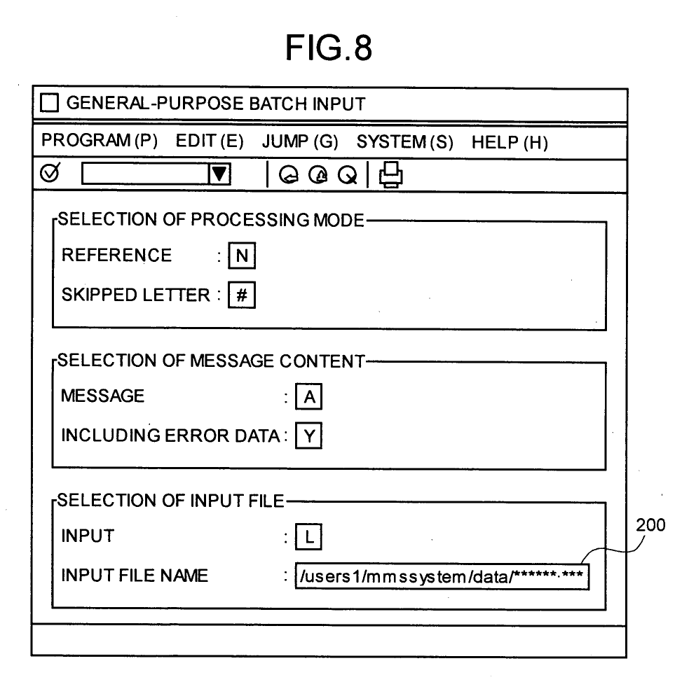

FIG. 7 illustrates an example of the contents in the generated conversion file. The user activates the general-purpose input tool, specifies the conversion file as shown in FIG. 7, and registers the contents in the spreadsheet in the integrated database 10 (step S104). FIG. 8 illustrates an example of a display screen in the general-purpose batch input tool. In the display example shown in FIG. 8, the user specifies the file name of the conversion file in an input box 200, and instructs the general-purpose batch input processing.

This general-purpose batch input processing is useful in master transfer or balance transfer at the time of introducing the ERP package. Moreover, it can be used when data fetch or customizing is performed from other systems.

The general-purpose batch input tool can be used in common between different transactions, and hence it is not necessary to develop and use the tool separately for each transaction, thereby improving the convenience of the user operation.

General-Purpose Batch Output Tool

The general-purpose batch output tool will be explained next. The general-purpose batch output tool is a tool for downloading the registered contents in the integrated database 10 to the client machine 30. As for the processing, at first, a name list of the table to be extracted is displayed by inputting the integrated database name to be extracted on the general-purpose batch output tool. The item for which the condition is to be input, and an item to be extracted are selected, to execute the processing. The extracted item and the like are obtained in a text file, and the contents in the text file can be confirmed, using the spreadsheet software or the like.

Accounting Data Batch Checking Tool

The accounting data batch checking tool will be explained next. The accounting data batch checking tool is a tool for confirming whether there is an error in the transferred accounting slip. As for the processing, at first, conditions relating to which accounting slip is to be checked are input on the accounting data batch checking application. An error result is obtained in a text file, and the contents in the text file can be confirmed by the list display by the spreadsheet software or the like.

Common Operation of Enterprise Resource Planning Tool

On the respective applications, being the enterprise resource planning tool, or the application of the respective ERP packages introduced in the enterprise resource planning application system according to the embodiment, various contrivances are considered to simplify the user operation.

At first, a contrivance for simplifying copy and paste, which are performed frequently, is proposed. This is performed by the setting of the respective applications, such that a letter to be copied is traced by the mouse, while pushing the left button, and at the end of the trace, the left button is released thereby to copy the letter. The mouse cursor is then shifted to a place to be pasted, and by pressing the left button once at that position, and pressing the right button, the traced letter is pasted.

The input support with respect to the input item is also realized. When alphanumeric characters are input to the input form, when the number of letters reaches the necessary number of input letters, the cursor shifts to the next input item automatically. By this setting, for example, in a column where a two-digit code is input, when two-digit code is input, the cursor shifts to the next input item automatically. As a result, an input error by the user can be reduced, and since a part of the cursor shift operation can be omitted, data input can be performed quickly.

Further, the search condition input support in the search processing with respect to the integrated database 10 is also realized. When the search condition to be input is unclear, the mouse is put in the input item, thereby a special icon button is made to appear on the right side, and by clicking the icon button, search help is displayed. This search help displays the list of codes and the like, which may be input in the input item, and selection is possible from the list.

Further, search by partial agreement is also possible as the search condition input support. This is for inputting “*” in the item to be searched, to display ones agreed partially in a list form. For example, when a client including “ABCD” in the name is to be searched, by inputting “*ABCD*”, the search result partially agreed therewith is displayed. In this case, when “ABCD*” is input, a client code starting with “ABCD” in the name is searched, and when “*ABCD” is input, a client code ending with “ABCD” in the name is searched.

As explained above, according to the enterprise resource planning application system and the enterprise resource planning method of the present invention, the business process can be executed only by using the standard functions prepared beforehand in the business package. As a result, there is the effect that the backbone business can be executed without performing extra development, such as adding a function characteristic to the type of business, and hence the introduction period of the enterprise resource planning application system can be considerably reduced.

Since function addition such as add-on can be suppressed as much as possible, the development period and development cost accompanying this can be reduced. Since the most part is the standard function portion, the enterprise resource planning application system (the ERP package) can flexibly deal with version-upgrades by the vendor thereof.

Since the most part of the business process is realized by the standard functions, there is an effect that the operation method can be easily limited, and the operation manual can be developed within short time and provided to the user.

Further, according to the enterprise resource planning application system and the enterprise resource planning method of the present invention, since data input for a transaction can be registered in the integrated database by the batch input unit used in common between different transactions, it is not necessary to individually provide a characteristic output interface different for each transaction, thereby improving the convenience for the user operation.

Industrial Applicability

The enterprise resource planning application system, the enterprise resource planning method, the program for making computer execute the method, and the computer readable recording medium having the program recorded therein according to the present invention are suitable for supporting execution of the backbone business of an enterprise in an integrated manner.

1-21. (cancelled)

22. An enterprise resource planning application system provided in the form of a plurality of business packages, for supporting a backbone executed by a computer system in an integrated manner, wherein
the enterprise resource planning application system extracts from a plurality of standard functions provided by the business packages standard functions that realize a business process common to different types of business, and executes the business process only by a combination of the standard functions extracted.

23. The enterprise resource planning application system according to claim 22, wherein
the business packages includes a package for financial accounting, and
the package performs general ledger accounting, accounts receivable management, accounts payable management, funds management, asset accounting, master processing, and settlement accounting, as the standard functions extracted to realize a business process common to different types of business.

24. The enterprise resource planning application system according to claim 22, wherein
the business packages includes a package for control accounting, and
the package performs cost element management, cost center accounting, profit center accounting, internal instruction management, and production instruction management, as the standard functions extracted to realize a business process common to different types of business.

25. The enterprise resource planning application system according to claim 22, wherein
the business packages includes a package for sales and distribution, and
the package performs purchase orders processing, shipping management, account management, stock transfer, consignment stock, master processing, sales information reporting, and sales planning, as the standard functions extracted to realize a business process common to different types of business.

26. The enterprise resource planning application system according to claim 22, wherein
the business packages includes a package for material management, and
the package performs purchase management, stock control, account checking, balance transfer, stock evaluation adjustment, and purchasing budget, as the standard functions extracted to realize a business process common to different types of business.

27. The enterprise resource planning application system according to claim 22, wherein
the business packages includes a package for a project system, and
the package performs project system processing and network processing, as the standard functions extracted to realize a business process common to different types of business.

28. The enterprise resource planning application system according to claim 22, wherein
the business packages includes a package for production planning, and
the package performs master processing, marketing planning, standard planning, material requirements planning, manufacturing instruction processing, and production analysis, as the standard functions extracted to realize a business process common to different types of business.

29. The enterprise resource planning application system according to claim 22, wherein
the business packages includes a package for plant maintenance, and
the package performs functional site and equipment processing, work center processing, maintenance task listing, maintenance planning, notification, and instruction processing, as the standard functions extracted to realize a business process common to different types of business.

30. An enterprise resource planning application system provided in the form of a plurality of business packages, for supporting a backbone executed by a computer system in an integrated manner, comprising:
standard functions that are extracted from a plurality of standard functions provided by the business packages to realize a business process common to different types of business; and
additional functions to realize a business process common to all types of business, wherein
the enterprise resource planning application system executes the business process by a combination of the standard functions extracted and the additional functions.

31. The enterprise resource planning application system according to claim 30, further comprising additional functions to realize a specific business process for an enterprise.

32. The enterprise resource planning application system according to claim 30, wherein
the business packages includes a package for financial accounting, and
the package performs general ledger accounting, accounts receivable management, accounts payable management, funds management, asset accounting, master processing, and settlement accounting, as the standard functions extracted to realize a business process common to different types of business.

33. The enterprise resource planning application system according to claim 30, wherein
the business packages includes a package for control accounting, and
the package performs cost element management, cost center accounting, profit center accounting, internal instruction management, and production instruction management, as the standard functions extracted to realize a business process common to different types of business.

34. The enterprise resource planning application system according to claim 30, wherein
the business packages includes a package for sales and distribution, and
the package performs purchase orders processing, shipping management, account management, stock transfer, consignment stock, master processing, sales information reporting, and sales planning, as the standard functions extracted to realize a business process common to different types of business.

35. The enterprise resource planning application system according to claim 30, wherein
the business packages includes a package for material management, and
the package performs purchase management, stock control, account checking, balance transfer, stock evaluation adjustment, and purchasing budget, as the standard functions extracted to realize a business process common to different types of business.

36. The enterprise resource planning application system according to claim 30, wherein
the business packages includes a package for a project system, and
the package performs project system processing and network processing, as the standard functions extracted to realize a business process common to different types of business.

37. The enterprise resource planning application system according to claim 30, wherein
the business packages includes a package for production planning, and
the package performs master processing, marketing planning, standard planning, material requirements planning, manufacturing instruction processing, and production analysis, as the standard functions extracted to realize a business process common to different types of business.

38. The enterprise resource planning application system according to claim 30, wherein
the business packages includes a package for plant maintenance, and
the package performs functional site and equipment processing, work center processing, maintenance task listing, maintenance planning, notification, and instruction processing, as the standard functions extracted to realize a business process common to different types of business.

39. An enterprise resource planning application system provided in the form of a plurality of business packages, for supporting by an integrated database a backbone executed by a computer system, comprising:
a data input unit for inputting data onto an input sheet for each transaction;
a data file conversion unit that converts the data input by the data input unit into a data file in a predetermined format; and
a batch input unit that registers contents of the data file in the integrated database, and is used in common between different transactions.

40. An enterprise resource planning method using a plurality of business packages, for supporting a backbone executed by a computer system in an integrated manner, comprising:
extracting standard functions from a plurality of standard functions provided by the business packages to realize a business process common to different types of business;
obtaining a template by combining the standard functions extracted; and
executing the business process based on the template.

41. An enterprise resource planning method using a plurality of business packages, for supporting a backbone executed by a computer system in an integrated manner, comprising:
extracting standard functions from a plurality of standard functions provided by the business packages to realize a business process common to different types of business;
obtaining a template by combining the standard functions extracted and additional functions to realize a business process common to all types of business; and
executing the business process based on the template.

42. The enterprise resource planning method according to claim 41, wherein the template includes additional functions to realize a specific business process for an enterprise.

43. An enterprise resource planning method using a plurality of business packages, for supporting by an integrated database a backbone executed by a computer system, comprising:
inputting data onto an input sheet for each transaction;
converting the data input into a data file in a predetermined format; and
registering contents of the data file in the integrated database through a batch input unit that is used in common between different transactions.

44. A computer program product which realizes an enterprise resource planning using a plurality of business packages for supporting a backbone executed by a computer system in an integrated manner, the computer program product including computer executable instructions stored on a computer readable medium, wherein the instructions, when executed by the computer, cause the.computer to perform:
extracting standard functions from a plurality of standard functions provided by the business packages to realize a business process common to different types of business;
obtaining a template by combining the standard functions extracted; and
executing the business process based on the template.

45. A computer program product which realizes an enterprise resource planning using a plurality of business packages for supporting a backbone executed by a computer system in an integrated manner, the computer program product including computer executable instructions stored on a computer readable medium, wherein the instructions, when executed by the computer, cause the computer to perform:
extracting standard functions from a plurality of standard functions provided by the business packages to realize a business process common to different types of business;
obtaining a template by combining the standard functions extracted and additional functions to realize a business process common to all types of business; and
executing the business process based on the template.

46. A computer program product which realizes an enterprise resource planning using an enterprise resource planning method which uses a plurality of business packages for supporting by an integrated database a backbone executed by a computer system, the computer program product including computer executable instructions stored on a computer readable medium, wherein the instructions, when executed by the computer, cause the computer to perform:
inputting data onto an input sheet for each transaction;
converting the data input into a data file in a predetermined format; and
registering contents of the data file in the integrated database through a batch input unit that is used in common between different transactions.
